(19) United States
(12) Patent Application Publication
(10) Pub. No.: US 2023/0247124 A1
(43) Pub. Date: Aug. 3, 2023

(54) MOBILE DEVICE HOLDER

(71) Applicant: CHARLES TAYLOR, Los Angeles, CA (US)

(72) Inventor: CHARLES TAYLOR, Los Angeles, CA (US)

(21) Appl. No.: 18/104,501

(22) Filed: Feb. 1, 2023

Related U.S. Application Data
(60) Provisional application No. 63/305,986, filed on Feb. 2, 2022.

(51) Int. Cl. H04M 1/04

(52) U.S. Cl. CPC H04M 1/04

(57) ABSTRACT

A mobile device holder for a shopping cart or similar carriage. The holder includes a carrier for a mobile device, with a base clamp at a lower edge for pivoting attachment to the shopping cart. A guide ridge is disposed at an upper edge of the holder and configured to facilitate sliding along a part of the shopping cart. The base clamp may include an extension arm to raise the holder above the shopping cart seating area. The base clamp may include a fastening plate to securely hold the base clamp to the shopping cart. Through the pivoting and sliding attachment to the shopping cart, the mobile device holder may collapse along with the seating area of the shopping cart.

### CROSS RELATED APPLICATIONS

This application relates to and claims priority from U.S. Provisional Application Serial No. 63/305,986 entitled MOBILE DEVICE HOLDER FOR A CART filed Feb. 2, 2022.

### FIELD OF THE INVENTION

Embodiments of the disclosure relate generally to physical systems for holding personal mobile devices. Specific embodiments relate to mobile device holders for grocery carts and other everyday apparatuses manipulated by a user.

### BACKGROUND OF THE INVENTION

The present invention is directed to a device holder for use by consumers, particularly a mobile device holder for use with shopping carts and similar carriages.

Most shopping carts and similar carriages do not provide convenient mobile device holders for users. More often than not, a user would simply hold their mobile device in one hand while steering the cart with the other hand. Alternatively, a user may bring their own device holder to clip-on or otherwise attach to a cart. Such stand-alone device holders may not be compatible with all carts or may interfere with the normal use of a cart. A stand-alone device holder may block a cart from collapsing a cart seat or may block use of a cart seat when installed.

Accordingly, there is a need for an improved device holder for a cart. The present invention fulfills these needs and provides other related advantages.

### SUMMARY OF THE INVENTION

The present invention is directed to a mobile device holder for a shopping cart that is designed to be compatible with the folding nature of seats on such carts. The mobile device holder of the present invention includes a substrate having two or more edge clips or retaining members designed to hold a smart phone or similar mobile device. Preferably, the substrate has four edge clips, one on each side of the substrate. More preferably, one or more of the edge clips are adjustable to accommodate mobile devices of varying sizes.

One edge, preferably a bottom edge of the substrate, includes a cart clip configured for semi-permanent or permanent attachment to a wire, bar, or other support on a cart. The edge clip may include an extension arm that spaces the cart clip from the bottom edge of the cart clip. Another edge, preferably an opposite or top edge of the substrate, includes a guide ridge that extends from the top or back of the substrate. The guide ridge either props the device holder up against an upright frame on the cart, or fits between two parallel frame bars on the cart for maintaining the device holder in an aligned position.

The cart clip on the bottom edge may pivotally attach to the front of a cart seat, mid-way on the cart seat, or anywhere in between the front and back edges. The guide ridge on the top edge leans against the upright frame to present the mobile device holder facing the user when the cart seat is in the fully open position. When the cart seat is moved to the closed position, the mobile device holder is designed to collapse with the cart seat, through the guide ridge sliding upwards along the upright frame. The cart clip is designed to remain in place but pivot between the open position and closed position of the cart seat.

In another embodiment, the mobile device holder includes a tilt bar or support arm pivotally attached to about the center back of the substrate. The opposite end of the tilt bar may attach to the back of the cart seat. In this embodiment, the bottom edge of the substrate may not have a cart clip so that the substrate can be positioned at any convenient angle to display the mobile device to the user. In this embodiment, the device holder would collapse against the upright frame of the cart seat when not in use.

Because of the collapsible design of the device holder, it can be conveniently folded so as to be out of the way when not in use. When folded out of the way, the device holder would not interfere with a child sitting in the cart seat or if the user wants to carry other items in the cart seat. In addition, the device holder can be positioned off to one side of the cart seat so that it can still be used while a child or sitting or shopping items are carried in the cart seat.

The present invention is directed to a mobile device holder for use with a substrate such as a shopping cart or similar vehicle having a wire-frame structure. The mobile device holder has a carrier with a first major surface and a second major surface. A base clamp is disposed on a first edge of the carrier, with the base clamp having a channel clip configured for pivotal attachment to the substrate - for example, a bar on the wire-frame structure. The first major surface of the carrier is bounded by a plurality of retaining members configured to receive the mobile device. A guide ridge is disposed on the second major surface proximate to a second edge of the carrier opposite the base clamp. The guide ridge being configured to slidingly rest against a portion of the substrate.

On the carrier of the mobile device holder, at least one of the plurality of retaining members is adjustable. The channel clip may be removeable from the substrate. The channel clip may also be slidingly attached to the substrate. The mobile device holder may also be configured to slidingly collapse with the substrate.

The base clamp may further include an extension arm such that the channel clip is distal from the first edge. The channel clip may further include a fastening plate configured to enclose the channel clip around the substrate.

Alternatively, the mobile device may include a support arm pivotally attached to the second major surface at a hinge, with the support arm having an anchor distal from the hinge. The anchor being configured for sliding securement to the substrate.

Other features and advantages of the present invention will become apparent from the accompanying drawings, which illustrate, by way of example, the principles of the invention

### BRIEF DESCRIPTION OF THE FIGURES

These and other features and advantages of the present invention will become appreciated, as the same becomes better understood with reference to the specification, claims and drawings herein:

FIG. 1 is a perspective view of a device embodying features of the present invention for a mobile device holder;

FIG. 2 is an environmental view of the device of FIG. 1 displaying features of an embodiment installed in the seating area of a shopping cart;

FIG. 3 is a perspective view of the device of FIG. 1 showing an embodiment with adjustable retaining members;

FIG. 4 is a side environmental view of an embodiment of the present invention for a mobile device holder installed in the seating area of a shopping cart in a generally open position;

FIG. 5 is a side environmental view of the device of FIG. 4 showing an embodiment installed in the seating area of a shopping cart in a partially closed position;

FIG. 6 is a side environmental view of the device of FIG. 4 showing an embodiment installed in the seating area of a shopping cart in a generally closed position;

FIG. 7 is an environmental side view of another version of the device embodying features of the present invention for a mobile device holder installed on an open cart seat;

FIG. 8 is an environmental side view of the device of FIG. 7 showing an embodiment installed on a closed cart seat;

FIG. 9 is a rear plan view of the device of FIG. 7 showing an embodiment in an upright position.

FIG. 10 is a perspective view of another embodiment of the present invention for a mobile device holder showing an embodiment providing secure attachment to a substrate.

FIG. 11 is a partial exploded view of the device of FIG. 10 showing features of the embodiment.

FIG. 12 is a perspective view of another embodiment of the present invention for a mobile device holder showing an embodiment providing removable attachment to a substrate.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” and “upper” or “top,” and “inner” or “outer,” may be used herein to describe one element’s relationship to another elements as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

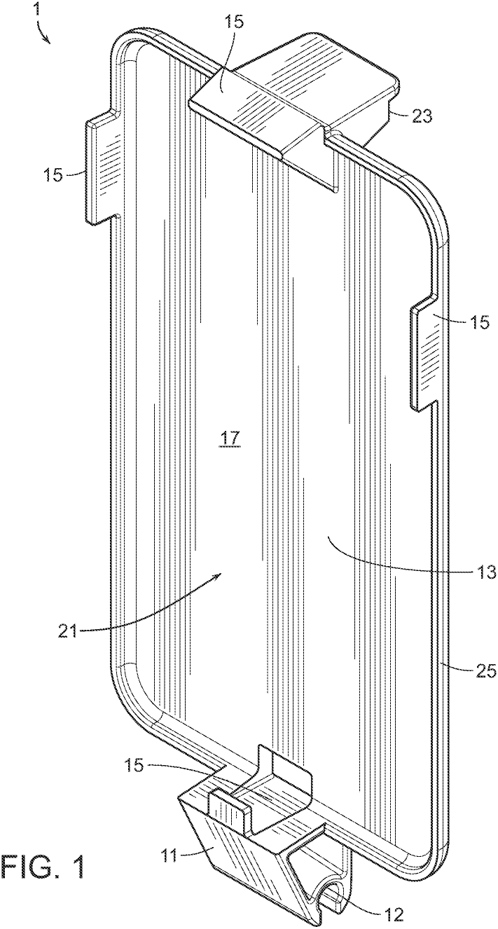

Embodiments of the present invention for a mobile device holder are generally referred to by reference numeral 1 in FIGS. 1-12. A mobile device holder 1 preferably includes a base member 11 attached to a lower edge of a carrier 13 having a plurality of retaining members 15. While the following description and accompanying drawings illustrate multiple embodiments articulating an illustrated size and shape, the inventive mobile device holder 1 may be provided in any size and shape, accommodating any size mobile device including but not limited to cellphones, tablets, or any other personal device of any desired size.

Embodiments of the present invention may be especially compatible with grocery carts, particularly the seating area, which presents an ideal substrate. This compatibility stems from a mobile device holder’s 1 ability to collapse and pivot with the seat of a grocery cart. The broad term “grocery cart” generally means the seating area near the push handle of a typical grocery cart. Such seating areas may collapse on some grocery carts and be fixed on others. The mobile device holder 1 is compatible with all such variations.

A typical grocery cart substrate generally comprises a storage bin on wheels with a smaller basket near the handle where a user pushes the bin. These smaller baskets may consist of the user-side wall of the cart, a seat, and a seat back. A seat back would be opposite the user-side wall of a bin. The seat and seat back may collapse or be fixed.

As shown in FIG. 1, a mobile device holder 1 may have any number of side walls or edge(s) 25, including a single edge 25. In a preferred embodiment, the present invention may include said base member 11 with a cart or channel clip 12 supporting said carrier 13. Said base member 11 may be disposed on an edge 25 of said carrier 13, preferably a lower edge, and configured to be pivotally attached to the shopping cart. Said base member 11 serves as an interface between the carrier 13 and said channel clip 12. In all embodiments, said clip 12 is generally sized and shaped to match the wires or bars on the shopping cart and such may be permanently or removably attached to the same.

The carrier 13 defines a first major surface 17 and a second major surface 19 and is preferably bounded by a plurality of retaining members 15 surrounding a void 21 into which a mobile device may be placed, with the retaining members 15 configured to receive and hold the mobile device. A guide ridge 23 may be disposed on said second major surface 19 proximate to an edge 25 opposite said base member 11. The device 1 may have at least one retaining member 15, but preferably has at least two but up to four retaining members 15. Said guide ridge 23 may optionally be disposed anywhere on said second major surface 19.

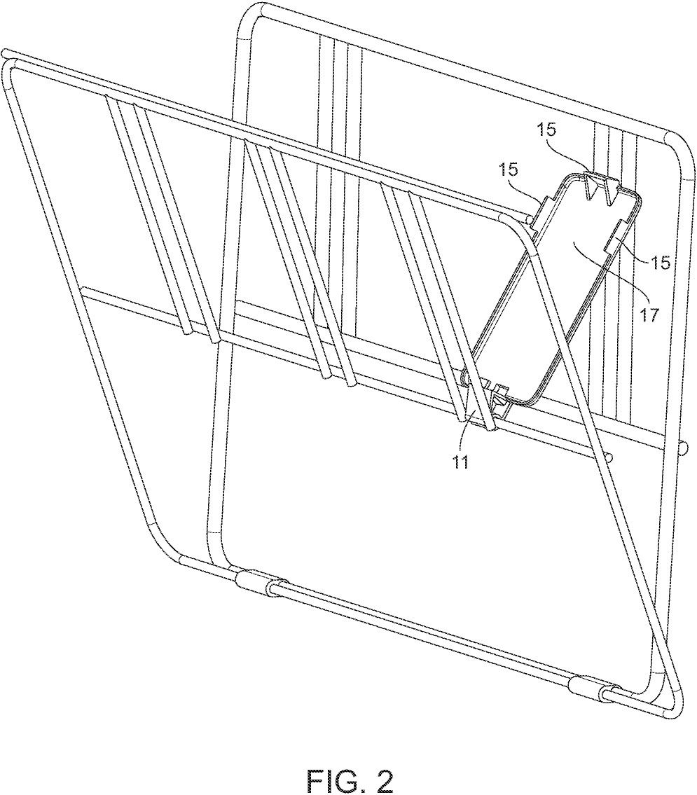

As shown in FIG. 2, said channel clip 12 and said guide ridge 23 allow support and interface between said mobile device holder 1 and the substrate. Said channel clip 12 may interface with a fixed part of the substrate, such as a wire or bar in grocery cart wall or seat. Said channel clip 12 permits rotation about the wire or bar of the substrate. This rotation allows a user to collapse the seating area or basket of the shopping cart without damaging said mobile device holder 1.

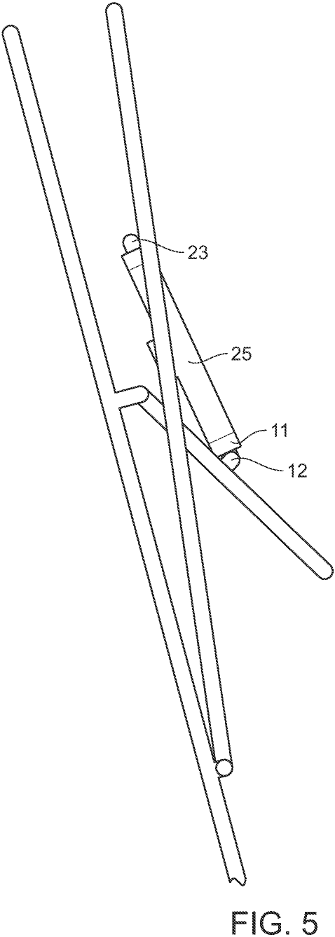

Rotation of the mobile device holder 1 is facilitated by said guide ridge 23 that slidingly associates along an axis with a wall of the substrate basket. Said guide ridge 23 allows said mobile device holder 1 to seamlessly rotate through collapse of the substrate basket. Said guide ridge 23 prevents said mobile device holder 1 from “snagging” or getting caught on features of a cart substrate. As shown in FIG. 2 said guide ridge 23 further provides structural support to said mobile device holder 1. Said guide ridge may be inserted between rods of a basket substrate preventing lateral movement across such a basket while users push the substrate as shown in FIGS. 2 and 5.

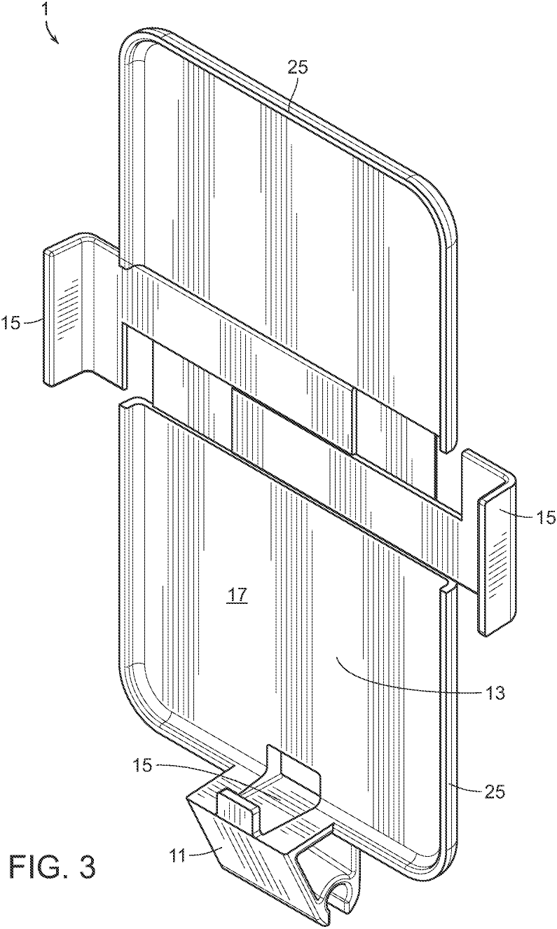

As shown in FIGS. 1 and 2, said mobile device holder 1 comprises a plurality of retaining members 15. Said retaining members 15 restrict movement of objects placed within the mobile device holder 1. As shown in FIG. 3 said plurality of retaining members 15 may be resiliently biased. This allows a mobile device carrier 1 to accommodate any number of mobile devices of varying dimensions. Any number of said retaining members 15 may be resiliently biased, but there are preferably at least two that are oppositely biased.

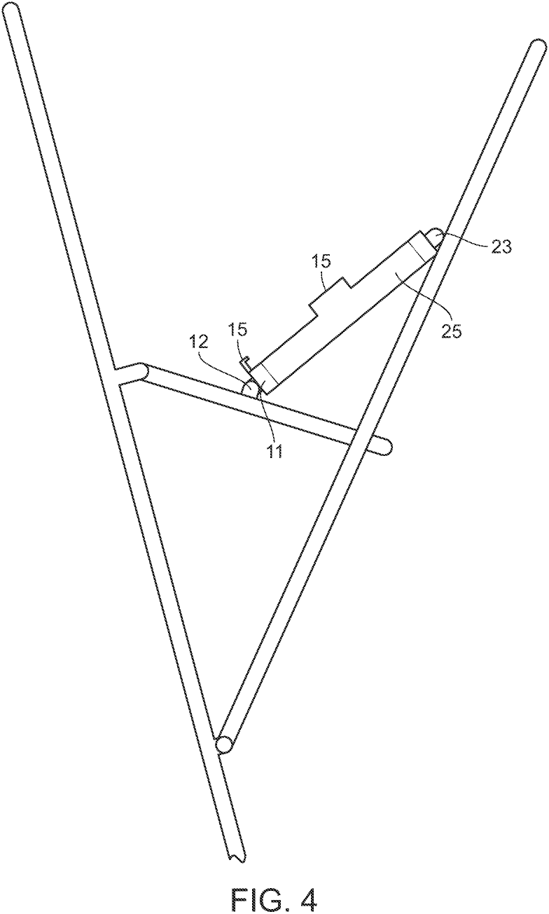

In another preferred embodiment said base member 11 with said channel clip 12 may be disposed onto to the “seat” of a substrate as shown in FIGS. 4-6. A seat may be the portion of a grocery cart basket that is generally parallel to the ground. This configuration allows a mobile device holder 1 to laterally slide across the seat of a substrate while retaining all inventive features allowing the mobile device holder 1 to collapse and deploy with a foldable substrate. This allows a user to move the mobile device holder 1 to one side of the basket to accommodate various dominant handedness and small children in the basket.

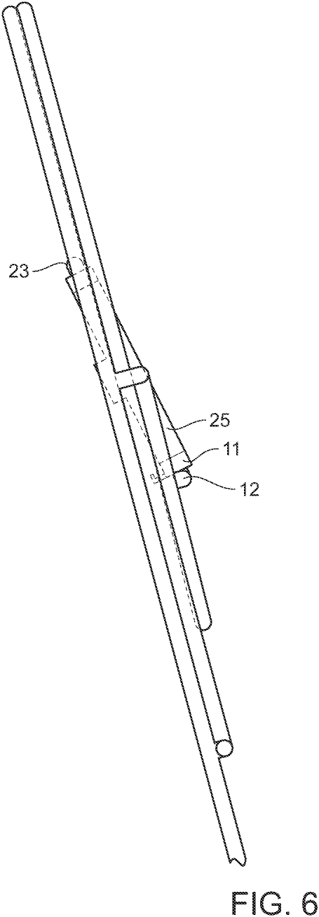

As shown in FIG. 4 said channel clip 12 is fixed to a substrate seat while said guide ridge 23 slidingly associates with a backrest of a substrate seat. As a user collapses a substrate seat back said guide ridge 23 interfaces with the seat back. This interface allows seamless transition as said base 11 and clip 12 freely rotate about an axis as shown in FIG. 5. When the substrate basket is not deployed, such as when multiple carts are stored together in sequence, said base member 11, said clip 12, and said guide ridge 23 allow said mobile device holder to fully collapse with a substrate as shown in FIG. 6.

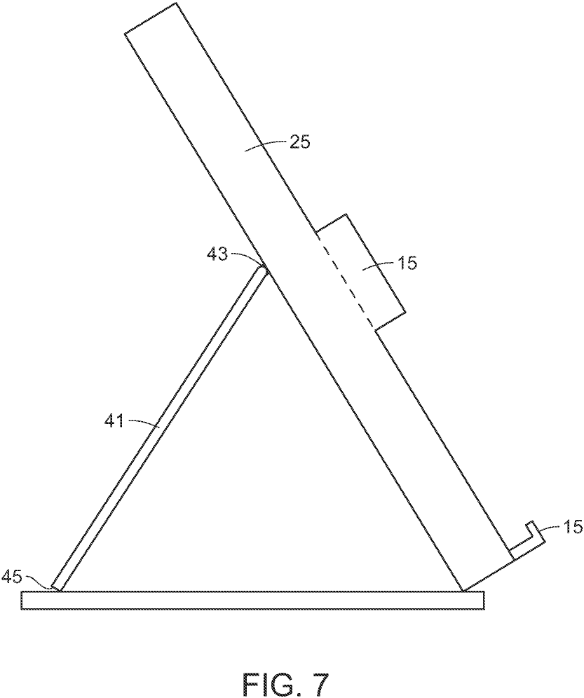

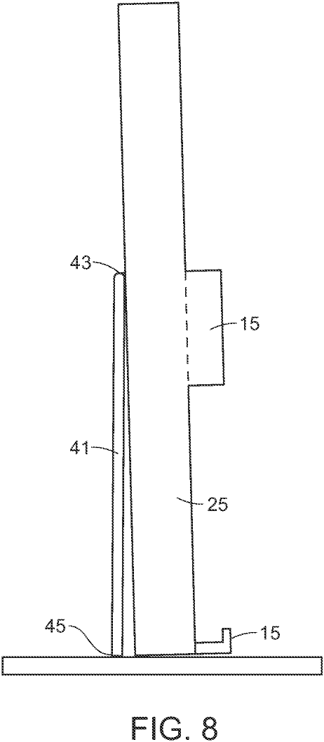

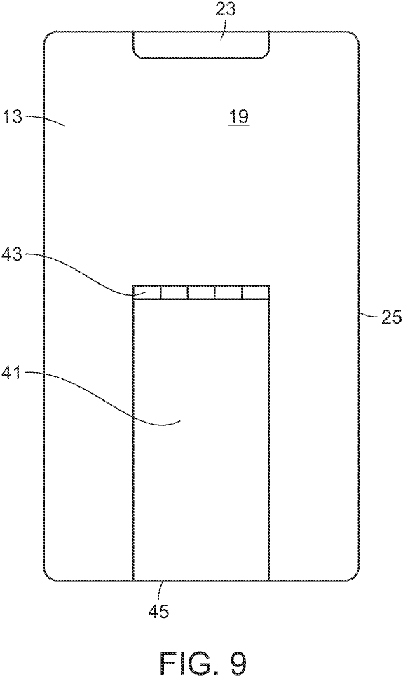

In another preferred embodiment, the addition of an inventive support arm 41 facilitates rotation of said mobile device holder 1 as shown in FIGS. 7-9. Said support arm 41 connects to said second major surface 19 of the mobile device holder 1 at a support joint 43. An anchor 45 is attached to an end of said support arm 41 opposite said support joint 43 and rotatably fixes said support arm 41 to the substrate as shown in FIGS. 7 and 9. Said support joint 43 allows a user to further rotate said mobile device holder 1 as may be needed. When a user chooses a desired display angle for the mobile device holder 1 said base member 11 and clip 12 removably attach to the substrate thereby maintaining the display angle facilitated by said support arm 41 and support joint 45. Said support arm 41 provides enhanced functionality while maintaining collapsible compatibility with the substrate as shown in FIG. 8 displaying a mobile device holder within a collapsed substrate basket.

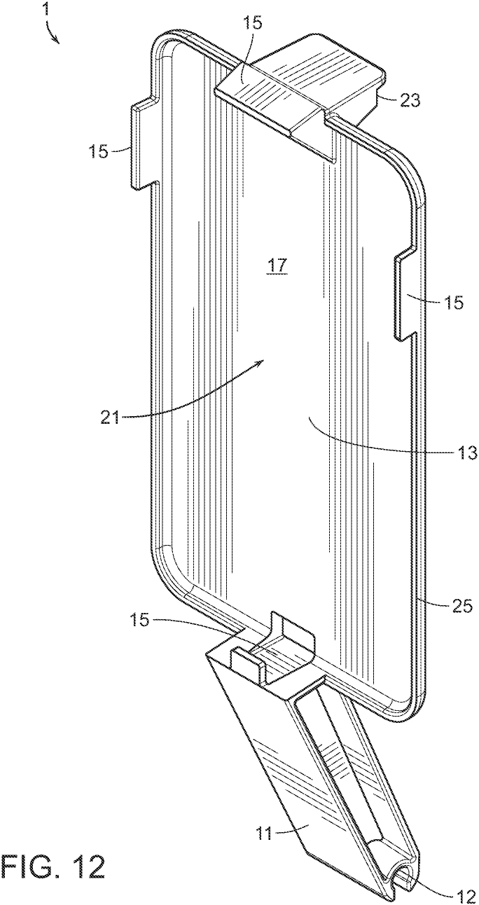

In another preferred embodiment an extender arm 53 may be introduced to the base clamp 11. In a structure similar to the earlier embodiments, as shown in FIG. 12, the extender arm 53 spaces channel clip 12 away from the edge 25 of the device 13. Said extender arm 51 increases the distance between said base clamp 11 and the substrate thereby increasing available volume for storage within a substrate basket. Said extender arm 53 reinforces said base clamp 11 with further structural support. This embodiment where the channel clip 12 is disposed at the end of the extender arm 53 functions in a manner similar to those embodiments described above.

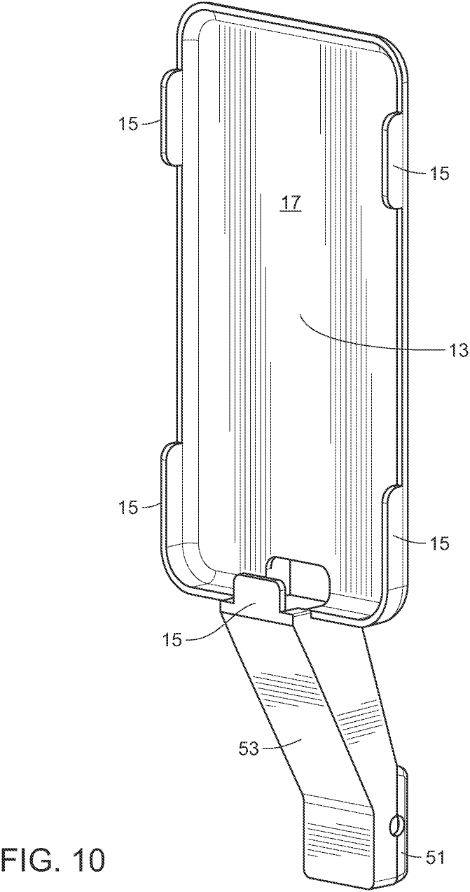

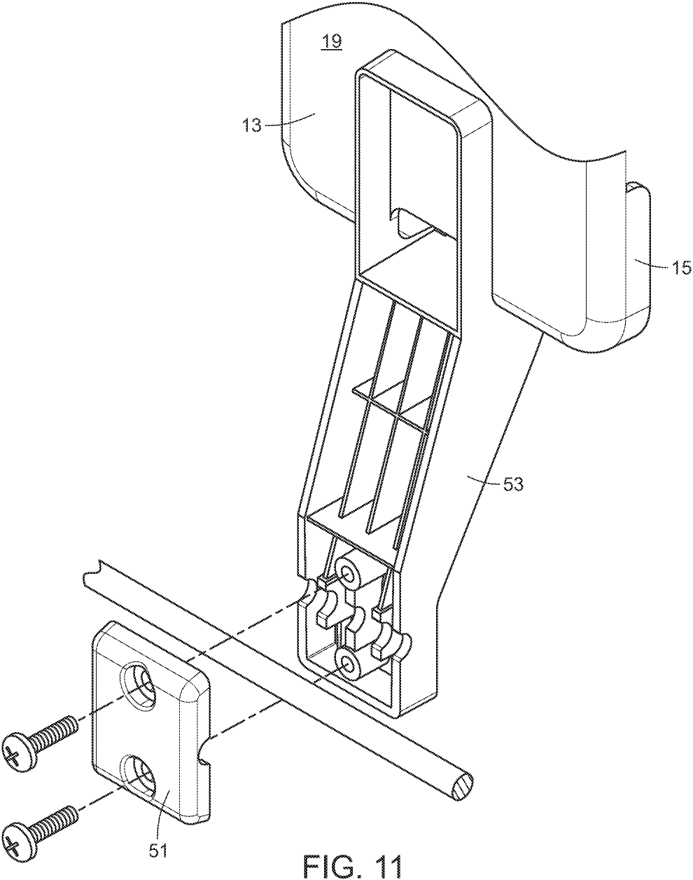

In a still further embodiment, shown in FIGS. 10 and 11, the base clamp 11 may include a fastener plate 51 configured for secure attachment over the channel clip 12 so as to surround and enclose a rod or wire from the substrate. The extender arm 53 with fastener plate 51 provides enhanced functionality and security to the interface between the mobile device holder 1 and substrate as shown in FIGS. 10 and 11. As shown in FIG. 11 the multipart composition of said fastener plate 51 affords customizable connections with more substrates, including bicycles and shower racks.

Although several embodiments have been described in detail for purposes of illustration, various modifications may be made without departing from the scope and spirit of the invention.

1. A mobile device holder, comprising:
a carrier having a first major surface and a second major surface;
a base clamp disposed on a first edge of the carrier, the base clamp having a channel clip configured for pivotal attachment to a substrate;
the first major surface of the carrier bounded by a plurality of retaining members configured to receive the mobile device; and
a guide ridge disposed on the second major surface proximate to a second edge opposite the base clamp, the guide ridge configured to slidingly rest against a portion of the substrate.

2. The mobile device holder of claim 1, wherein at least one of the plurality of retaining members is adjustable.

3. The mobile device holder of claim 1, wherein the channel clip is removeable from the substrate.

4. The mobile device holder of claim 1, wherein the channel clip is also slidingly attached to the substrate.

5. The mobile device holder of claim 1, wherein said mobile device holder is configured to slidingly collapse with the substrate.

6. The mobile device holder of claim 1, wherein the base clamp further comprises an extension arm such that the channel clip is distal from the first edge.

7. The mobile device holder of claim 6, wherein the channel clip further comprises a fastening plate configured to enclose the channel clip around the substrate.

8. The mobile device of claim 1, further comprising a support arm pivotally attached to the second major surface at a hinge and having an anchor distal from the hinge, the anchor configured for sliding securement to the substrate.

9. A mobile device holder, comprising:
a carrier having a first major surface and a second major surface;
a base clamp disposed on a first edge of the carrier, the base clamp having an extension arm and a channel clip distal from the first edge, the channel clip configured for pivotal and sliding attachment to a substrate;
the first major surface of the carrier bounded by a plurality of retaining members configured to receive the mobile device; and
a guide ridge disposed on the second major surface proximate to a second edge opposite the base clamp, the guide ridge configured to slidingly rest against a portion of the substrate.

10. The mobile device holder of claim 9, wherein at least one of the plurality of retaining members is adjustable.

11. The mobile device holder of claim 9, wherein the channel clip is removeable from the substrate.

12. The mobile device holder of claim 9, wherein said mobile device holder is configured to slidingly collapse with the substrate.

13. The mobile device holder of claim 9, wherein the channel clip further comprises a fastening plate configured to enclose the channel clip around the substrate.

14. The mobile device of claim 9, further comprising a support arm pivotally attached to the second major surface at a hinge and having an anchor distal from the hinge, the anchor configured for sliding securement to the substrate.

15. A mobile device holder, comprising:
a carrier having a first major surface and a second major surface;
a base clamp disposed on a first edge of the carrier, the base clamp having an extension arm and a channel clip distal from the first edge, with a fastening plate configured to enclose the channel clip, the channel clip and fastening plate configured for pivotal and sliding enclosed attachment to a substrate;
the first major surface of the carrier bounded by a plurality of retaining members configured to receive the mobile device, wherein at least one of the plurality of retaining members is adjustable; and
a guide ridge disposed on the second major surface proximate to a second edge opposite the base clamp, the guide ridge configured to slidingly rest against a portion of the substrate.

16. The mobile device holder of claim 15, wherein said mobile device holder is configured to slidingly collapse with the substrate.

17. The mobile device of claim 15, further comprising a support arm pivotally attached to the second major surface at a hinge and having an anchor distal from the hinge, the anchor configured for sliding securement to the substrate.
